(19) United States
(12) Patent Application Publication
(10) Pub. No.: US 2026/0331812 A1
(43) Pub. Date: Oct. 22, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Teruo HARA, Mie (JP); Takuma YOSHIOKA, Mie (JP)

(21) Appl. No.: 19/109,563

(22) PCT Filed: Aug. 24, 2023
(86) PCT No.: PCT/JP2023/030405

§ 371 Date: Mar. 7, 2025

(30) Foreign Application Priority Data
Sep. 14, 2022 (JP) 2022-145923

(51) Int. Cl. H01R 13/424; H01R 13/11; H01R 13/436

(52) U.S. Cl. CPC H01R 13/424; H01R 13/113; H01R 13/4361

(57) ABSTRACT

A connector includes a housing, a locking lance, an opening and an outer wall portion. The housing includes a cavity, into which a terminal fitting is inserted. The locking lance locks and retains the terminal fitting inserted into the cavity and is resiliently deformable. The opening is open in an outer wall surface of the housing and enables the locking lance to be exposed on the outer wall surface. The outer wall portion is attached to the housing to cover the opening. The outer wall portion moves to a separated position separated from the locking lance to allow resilient deformation of the locking lance and a close position close to the locking lance to hold the locking lance in a state locked to the terminal fitting by suppressing the resilient deformation of the locking lance.

### TECHNICAL FIELD

The present disclosure relates to a connector.

### BACKGROUND

Patent Document 1 discloses a connector provided with a locking lance in a cavity. The locking lance can be resiliently deformed by a terminal fitting if the terminal fitting is inserted into the cavity, and can resiliently return and retain the terminal fitting if the terminal fitting reaches a proper position in the cavity.

### PRIOR ART DOCUMENT

### Patent Document

Patent Document 1: JP 2021-018907 A

### SUMMARY OF THE INVENTION

### Problems to be Solved

The connector of Patent Document 1 is provided with a deflection space for the locking lance in a connector housing. However, this space is a space used for the deflection of the locking lance when the terminal fitting is inserted into the cavity and not used after the terminal fitting is locked by the locking lance. Thus, in the case of realizing the size reduction of the connector, the formation of such a space may hinder the size reduction of the connector.

The present disclosure was completed on the basis of the above situation and aims to provide a connector easily reduced in size.

### Means to Solve the Problem

The present disclosure is directed to a connector with a housing including a cavity, a terminal fitting being inserted into the cavity, a resiliently deformable locking lance for locking and retaining the terminal fitting inserted into the cavity, an opening open in an outer wall surface of the housing, the opening enabling the locking lance to be exposed on the outer wall surface, and an outer wall portion to be attached to the housing to cover the opening, the outer wall portion moving to a separated position separated from the locking lance to allow resilient deformation of the locking lance and a close position close to the locking lance to hold the locking lance in a state locked to the terminal fitting by suppressing the resilient deformation of the locking lance.

### Effect of the Invention

According to the present disclosure, a connector is easily reduced in size.

### BRIEF DESCRIPTION OF THE DRAWINGS

FIG. 1 is an exploded perspective view of a connector according to an embodiment.

FIG. 2 is a perspective view of a housing.

FIG. 3 is a perspective view of a movable member.

FIG. 4 is a perspective view of the connector in a state where an outer wall portion is at a separated position.

FIG. 5 is a side view of the connector in the state where the outer wall portion is at the separated position.

FIG. 6 is a section along A-A in FIG. 5.

FIG. 7 is a section along B-B in FIG. 5.

FIG. 8 is a side view in section of the connector in the state where the outer wall portion is at the separated position.

FIG. 9 is a section along A-A in FIG. 5 showing a state where the outer wall portion is at a close position.

FIG. 10 is a section along B-B in FIG. 5 showing the state where the outer wall portion is at the close position.

FIG. 11 is a side view in section of the connector in the state where the outer wall portion is at the close position.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing, a locking lance, an opening and an outer wall portion. The housing includes a cavity, into which a terminal fitting is inserted. The locking lance locks and retains the terminal fitting inserted into the cavity and is resiliently deformable. The opening is open in an outer wall surface of the housing and enables the locking lance to be exposed on the outer wall surface. The outer wall portion is attached to the housing to cover the opening. The outer wall portion moves to a separated position separated from the locking lance to allow resilient deformation of the locking lance and a close position close to the locking lance to hold the locking lance in a state locked to the terminal fitting by suppressing the resilient deformation of the locking lance. According to this configuration, the outer wall portion is moved to the separated position in inserting or withdrawing the terminal fitting into or from the cavity, thereby forming a space, into which the locking lance is resiliently deformable. The space for the resilient deformation of the locking lance can be eliminated by moving the outer wall portion to the close position after the terminal fitting is inserted into the cavity. In this way, it is possible to suppress the formation of a dead space in the housing after the terminal fitting is inserted into the cavity.

(2) Preferably, the connector of the present disclosure is further provided with a retainer to be attached to the housing. Preferably, the outer wall portion is integrally formed to the retainer, and the retainer is arranged at a temporary locking position for allowing insertion of the terminal fitting into the cavity when the outer wall portion is at the separated position. Preferably, the retainer is arranged at a complete locking position for locking and retaining the terminal fitting inserted to a proper position in the cavity when the outer wall portion is at the close position. According to this configuration, since the outer wall portion and the retainer are integrally formed, the outer wall portion and the retainer can be collectively moved, whereby two functions of suppressing the resilient deformation of the locking lance and completely locking the terminal fitting can be exhibited by one operation.

(3) Preferably, in the connector of the present disclosure, a jig insertion opening is open between a front end of the housing and a front end part of the outer wall portion, a jig for operating the locking lance being inserted through the jig insertion opening. Preferably, an opening dimension of the jig insertion opening in a moving direction of the outer wall portion to the separated position and the close position is an insertable dimension for enabling insertion of the jig when the outer wall portion is at the separated position. Preferably, the opening dimension is an insertion suppressing dimension for suppressing the insertion of the jig when the outer wall portion is at the close position. According to this configuration, it is possible to suppress the insertion of the jig when the outer wall portion is at the close position and the resilient deformation of the locking lance is suppressed.

(4) Preferably, in the connector of the present disclosure, the housing includes a plurality of the cavities, and the outer wall portion includes a partition wall for partitioning the jig insertion opening to correspond to the respective cavities. According to this configuration, the jig is reliably and easily inserted into the necessary cavity.

(5) Preferably, in the connector of the present disclosure, a front end part of the housing is formed with a penetrating insertion hole, a mating terminal fitting being inserted into the cavity through the insertion hole, and provided with a partitioning portion for partitioning the insertion hole and the jig insertion opening. According to this configuration, erroneous insertion of the jig into the cavity can be prevented by the partitioning portion.

(6) Preferably, the outer wall portion of the connector of the present disclosure is arranged in front of the retainer on a front end part of the housing. Preferably, a front end part of the outer wall portion is provided with a first locking portion to be locked to the housing. Preferably, a second locking portion to be locked to the housing is provided behind the first locking portion on the outer wall portion. According to this configuration, by locking the front end part of the outer wall portion to the housing by the first locking portion, it can be suppressed that the position of the front end part of the outer wall portion with respect to the housing becomes unstable.

(7) Preferably, in the connector of the present disclosure, a stress generated during resilient deformation of the locking lance is within a resilience limit range of the locking lance when the locking lance is deformed to contact the outer wall portion at the separated position. According to this configuration, plastic deformation of the locking lance (the locking lance kept deformed) can be prevented.

### Details of Embodiment of Present Disclosure

### Embodiment

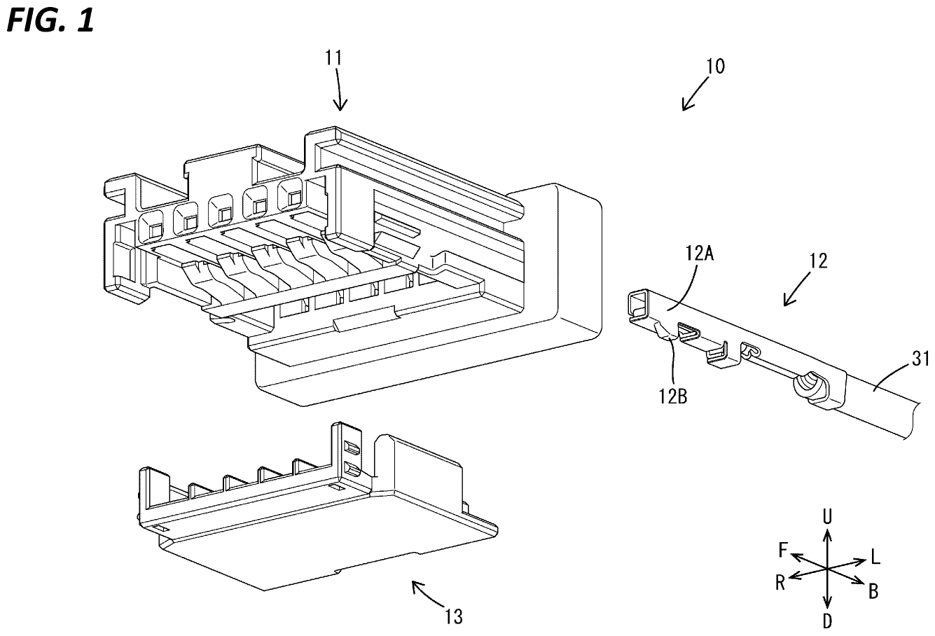

A specific connector 10 of the present disclosure is described with reference to FIGS. 1 to 11. In figures, “F”, “B”, “U”, “D”, “R” and “L” respectively represent a “front side”, a “back side”, an “upper side”, a “lower side”, “a right side” and a “left side”. In this embodiment, a lateral direction corresponds to a width direction. As shown in FIG. 1, the connector 10 is provided with a housing 11, terminal fittings 12 and a movable member 13.

### Configuration of Housing

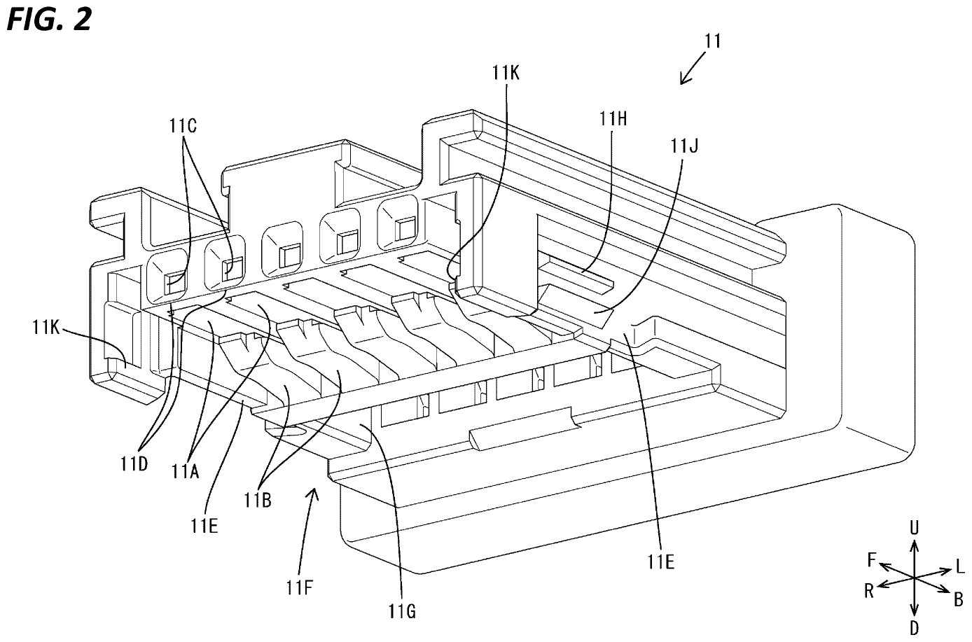

The housing 11 is made of synthetic resin. The housing 11 is in the form of a bilaterally symmetrical block as a whole. As shown in FIG. 2, a plurality of (five in this embodiment) cavities 11A penetrating through the housing 11 in a front-rear direction are formed side by side in the lateral direction (width direction) in the housing 11. Each cavity 11A is provided with a locking lance 11B cantilevered forward along the lower surface of the cavity 11A. The locking lance 11B has a function of locking and retaining the terminal fitting 12 inserted into the cavity 11A. The locking lance 11B is resiliently deformable downward.

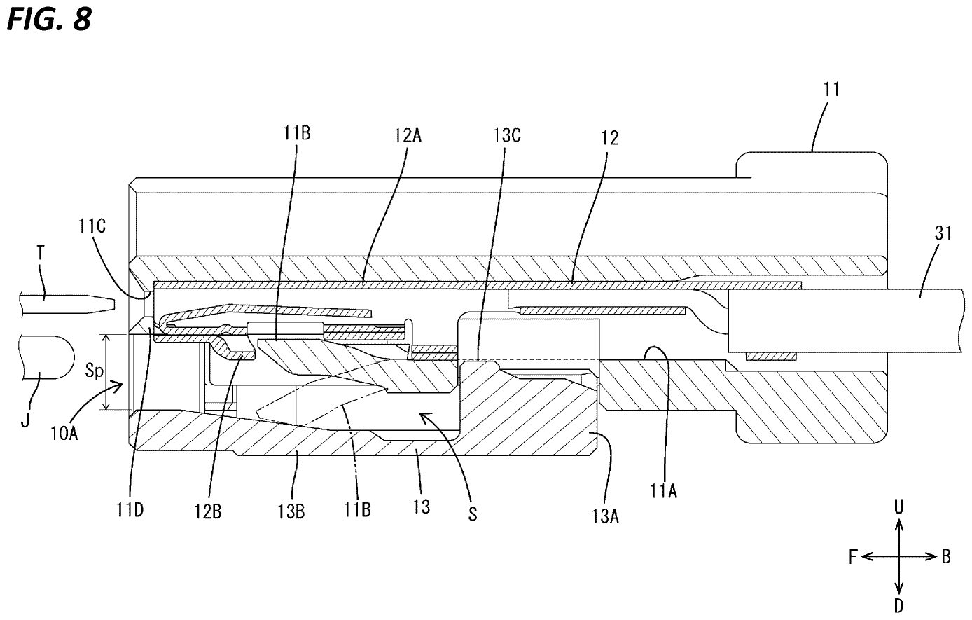

Insertion holes 11C, through which mating terminal fittings T (see FIG. 8) are inserted into the cavities 11A from front, are formed to penetrate through a front end part of the housing 11. Partitioning portions 11D are provided below the insertion holes 11C along the lower end edges of the insertion holes 11C. The partitioning portions 11D are provided along a lower end edge part of the front end part of the housing 11.

A pair of extending portions 11E extending downward are provided on both side edges in the lateral direction of the housing 11. An opening 11F is formed between the pair of extending portions 11E on a lower side of the housing 11. The opening 11F is open in the outer wall surface of the housing 11 from a central part in the front-rear direction to the front end of the housing 11 and formed to expose the cavities 11A and the locking lances 11B on the outer wall surface. The housing 11 is recessed upward behind the locking lances 11B, thereby forming a retainer insertion hole 11G. The retainer insertion hole 11G is located behind the opening 11F and communicates with each cavity 11A.

A complete locking projection 11H and a temporary locking projection 11J projecting outward in the lateral direction are provided on the laterally outer surface of each of the pair of the extending portions 11E. The complete locking projection 11H and the temporary locking projection 11J are formed to extend long in the front-rear direction. The complete locking projection 11H is arranged above the temporary locking projection 11J. A locking claw 11K projecting laterally inward is provided on a lower end part of a laterally inner side in a front end part of each of the pair of extending portions 11E. The locking claw 11K is arranged in front of and below the complete locking projection 11H and the temporary locking projection 11J.

### Configuration of Terminal Fitting

The terminal fitting 12 is made of electrically conductive metal. As shown in FIG. 1, the terminal fitting 12 is connected to an end part of a wire 31 and provided with a box portion 12A in the form of a rectangular tube in a front part. A tab of the mating terminal fitting T is inserted and connected to the box portion 12A. The terminal fitting 12 includes a retaining portion 12B projecting downward from the lower surface of the box portion 12A. The terminal fitting 12 is inserted into each cavity 11A from behind.

### Configuration of Movable Member

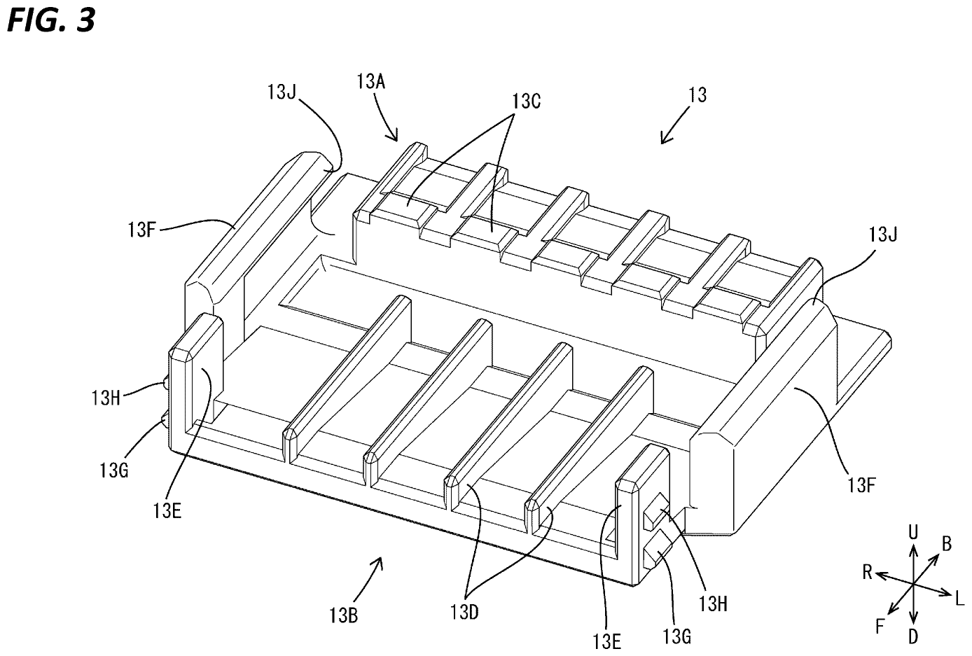

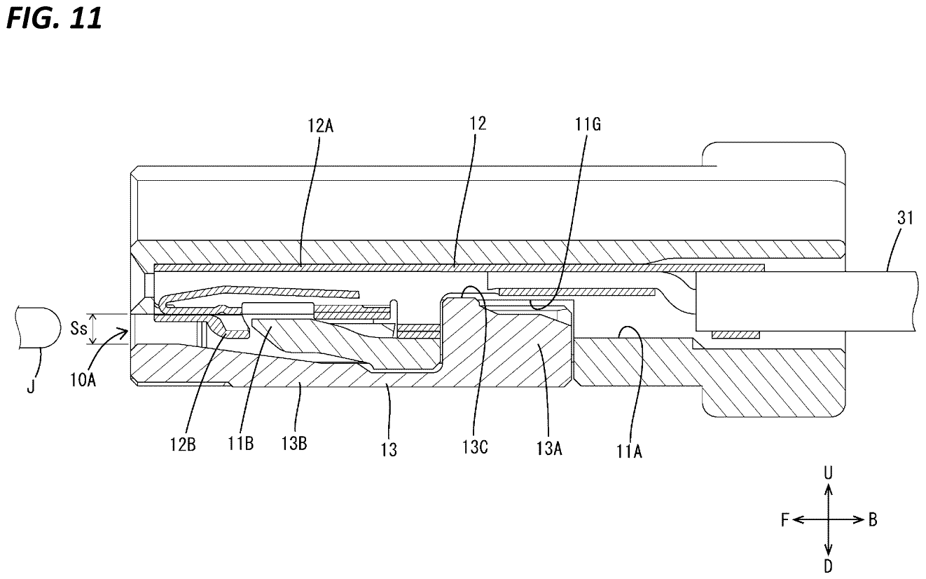

The movable member 13 is made of synthetic resin. As shown in FIG. 3, the movable member 13 is configured as a single component in the form of a bilaterally symmetrical block as a whole. The movable member 13 includes a retainer 13A and an outer wall portion 13B. The retainer 13A is formed to be long in the lateral direction and arranged in a rear end part of the movable member 13. A plurality of locking portions 13C projecting upward are arranged in parallel in the lateral direction on a front side of an upper end part of the retainer 13A. These locking portions 13C are locked to the rear ends of the box portions 12A of the terminal fittings 12 inserted into the cavities 11A from behind (see FIG. 11).

The outer wall portion 13B is plate-like and has a plate thickness direction oriented in the vertical direction. The outer wall portion 13B is arranged in front of the retainer 13A and integrally formed to the retainer 13A. The outer wall portion 13B includes a plurality of partition walls 13D, a pair of first locking portions 13E and a pair of second locking portions 13F.

The plurality of partition walls 13D are in the form of flat plates and have a plate thickness direction oriented in the lateral direction. These partition walls 13D are arranged at equal intervals in the lateral direction and formed to project upward from the upper surface of the outer wall portion 13B.

The pair of first locking portions 13E are in the form of flat plates and have a plate thickness direction oriented in the lateral direction. One first locking portion 13E is provided to rise from each of both side edges in the lateral direction of the front end part of the outer wall portion 13B. A close position projection 13G and a separated position projection 13H projecting laterally outward are provided on the laterally outer surface of each of the pair of first locking portions 13E. The close position projection 13G is arranged below the separated position projection 13H.

The pair of second locking portions 13F are in the form of flat plates and have a plate thickness direction oriented in the lateral direction. One second locking portion 13F is arranged to rise from each of both side edges in the lateral direction of the outer wall portion 13B. The second locking portion 13F is provided at a position separated from the first locking portion 13E behind the first locking portion 13E on the outer wall portion 13B. A locking projection 13J projecting inward in the lateral direction is provided on an upper end part of a laterally inner side of each of the pair of second locking portions 13F. The locking projection 13J is formed to be long in the front-rear direction and arranged along the upper end edge of the second locking portion 13F. The locking projection 13J is arranged above the close position projection 13G and the separated position projection 13H.

### Attachment of Movable Member and Terminal Fittings to Housing

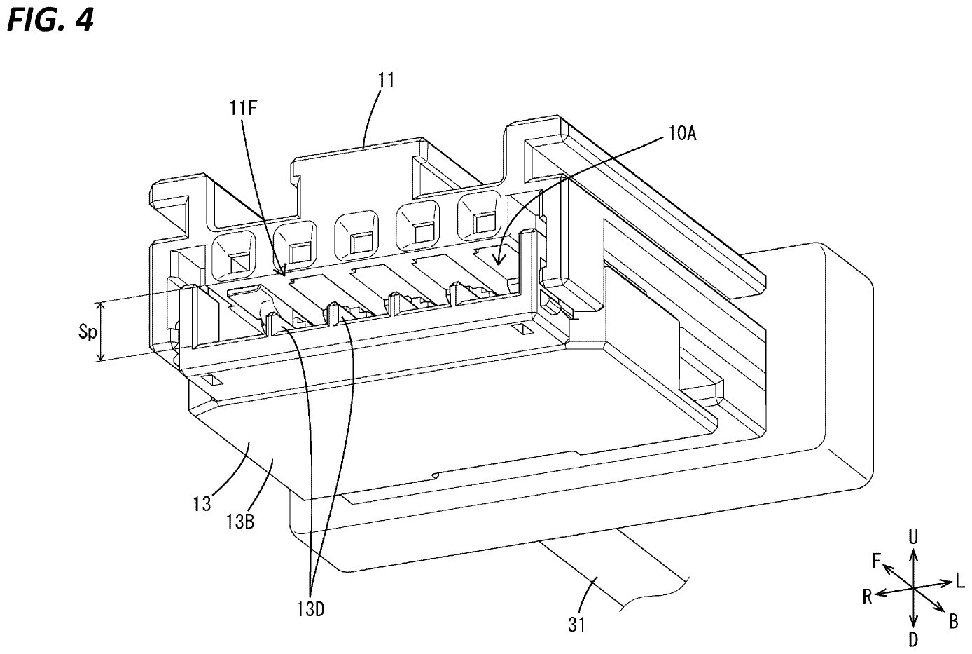

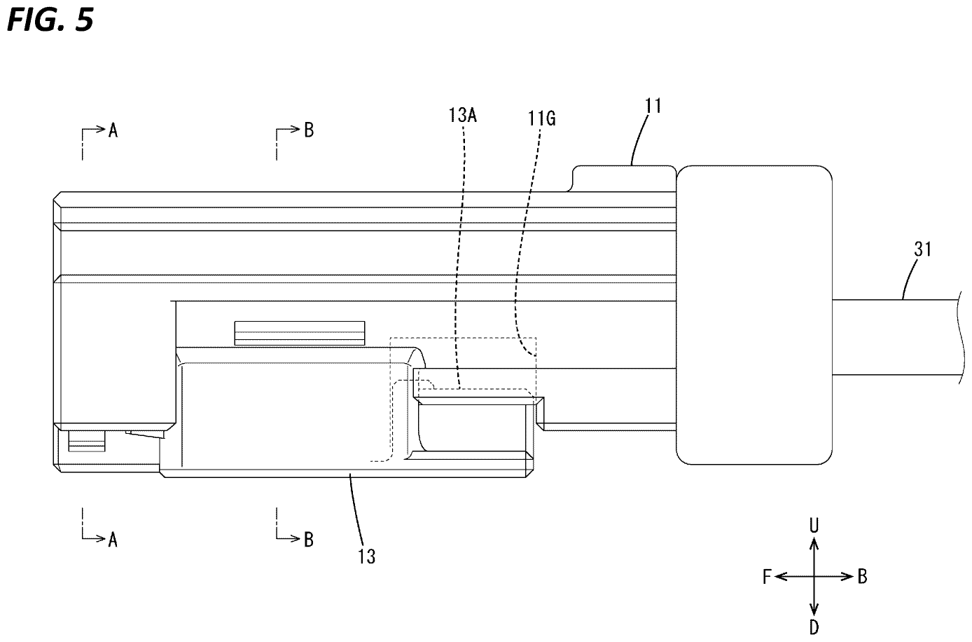

The movable member 13 thus formed is attached to the housing 11 from below. Specifically, the outer wall portion 13B of the movable member 13 is attached to cover the opening 11F of the housing 11 (see FIG. 4). Along with this, the retainer 13A of the movable member 13 is inserted and mounted into the retainer insertion hole 11G of the housing 11 from below (see FIG. 5).

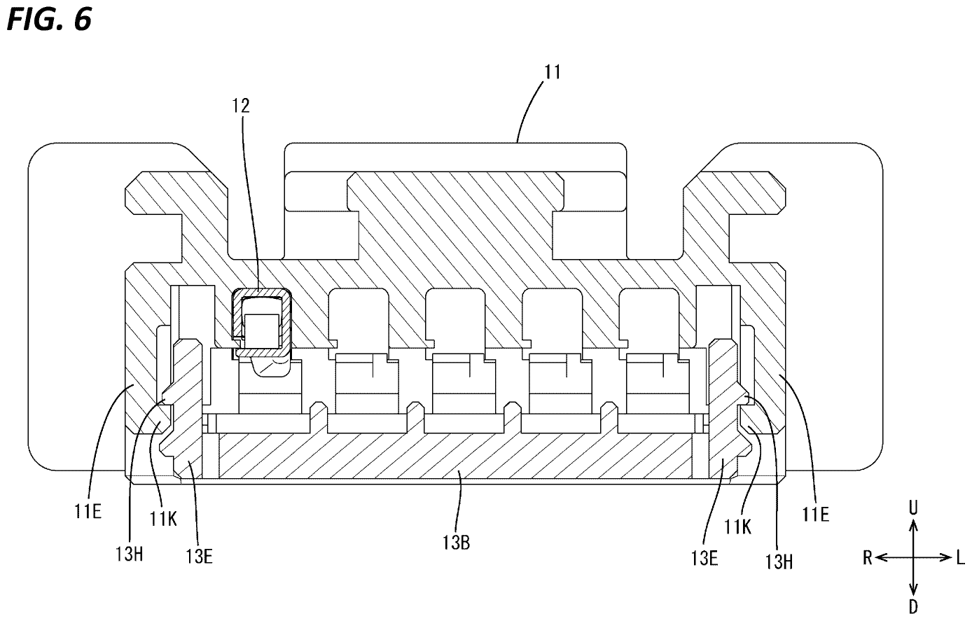

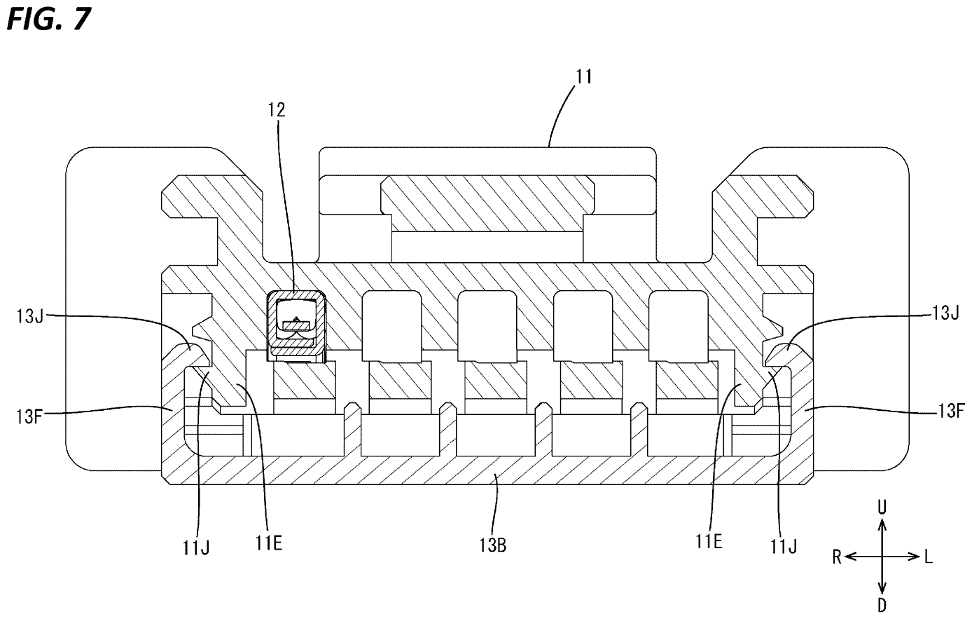

First, the pair of first locking portions 13E of the outer wall portion 13B are inserted between the pair of extending portions 11E and the pair of second locking portions 13F are arranged to cover the pair of extending portions 11E from outside in the lateral direction. The separated position projections 13H of the first locking portions 13E pass upward through the locking claws 11K of the extending portions 11E and are locked to the locking claws 11K (see FIG. 6). Along with this, the temporary locking projections 11J of the extending portions 11E are additionally locked to the locking claws 13J with the locking claws 13J of the second locking portions 13F facing downward (see FIG. 7). In this way, the first and second locking portions 13E, 13F are locked to the housing 11. At this time, the outer wall portion 13B is arranged at the separated position separated from the locking lances 11B while being located below the locking lances 11B, which are not resiliently deformed (see FIG. 8). With the outer wall portion 13B arranged at the separated position, deflection allowing spaces S are formed between the lower surfaces of the locking lances 11B and the upper surface of the outer wall portion 13B and the locking lances 11B are allowed to be resiliently deformed downward (see FIG. 8). At this time, an interval between the lower surface of the locking lance 11B and the upper surface of the outer wall portion 13B is set to be larger than a dimension necessary to disengage the locking lance 11B from the terminal fitting 12.

As shown in FIG. 8, when the outer wall portion 13B is at the separated position, the locking portions 13C of the retainer 13A are not in the cavities 11A. At this time, the retainer 13A is arranged at a temporary locking position for allowing the insertion of the terminal fittings 12 into the cavities 11A.

As shown in FIG. 4, with the movable member 13 attached to the housing 11, a jig insertion opening 10A is formed to be open between the front end of the housing 11 and the front end part of the outer wall portion 13B. The jig insertion opening 10A is formed to be long in the lateral direction. The plurality of partition walls 13D provided on the outer wall portion 13B are arranged to partition the jig insertion opening 10A in the lateral direction to correspond to the respective cavities 11A. A jig J (see FIG. 8) is inserted into the jig insertion opening 10A from front. When the outer wall portion 13B is at the separated position, an opening dimension in the vertical direction of the jig insertion opening 10A is an insertable dimension Sp for enabling the insertion of the jig J.

The jig J inserted into the jig insertion opening 10A can contact a front end part of the locking lance 11B and operate the locking lance 11B to resiliently deform the locking lance 11B downward. With the outer wall portion 13B located at the separated position, if the locking lance 11B is resiliently deformed downward, a tip part of the locking lance 11B butts against the upper surface of the outer wall portion 13B at the separated position in a resilient deformation range of the locking lance 11B as shown in FIG. 8. In other words, when the locking lance 11B is deformed to contact the outer wall portion 13B at the separated position, a stress generated during the resilient deformation of the locking lance 11B is within a resilience limit range of the locking lance 11B. In this way, the plastic deformation of the locking lance 11B is prevented. The partitioning portions 11D of the housing 11 are arranged to partition the plurality of insertion holes 11C and the jig insertion opening 10A. This prevents the jig J from erroneously entering the plurality of insertion holes 11C.

Subsequently, the terminal fitting 12 is inserted into the cavity 11A with the outer wall portion 13B located at the separated position and the retainer 13A located at the temporary locking position. In the process of inserting the terminal fitting 12, the locking lance 11B is pressed downward and resiliently deformed by the box portion 12A and the retaining portion 12B. When the terminal fitting 12 reaches a proper insertion position, the locking lance 11B resiliently returns upward and locks the retaining portion 12B and the terminal fitting 12 is held retained by this locking action.

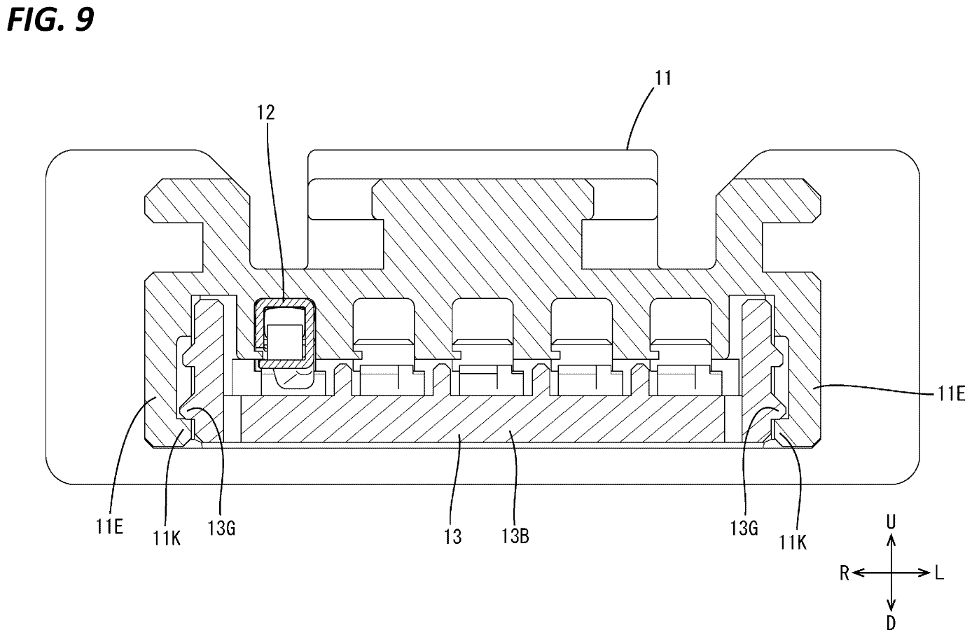

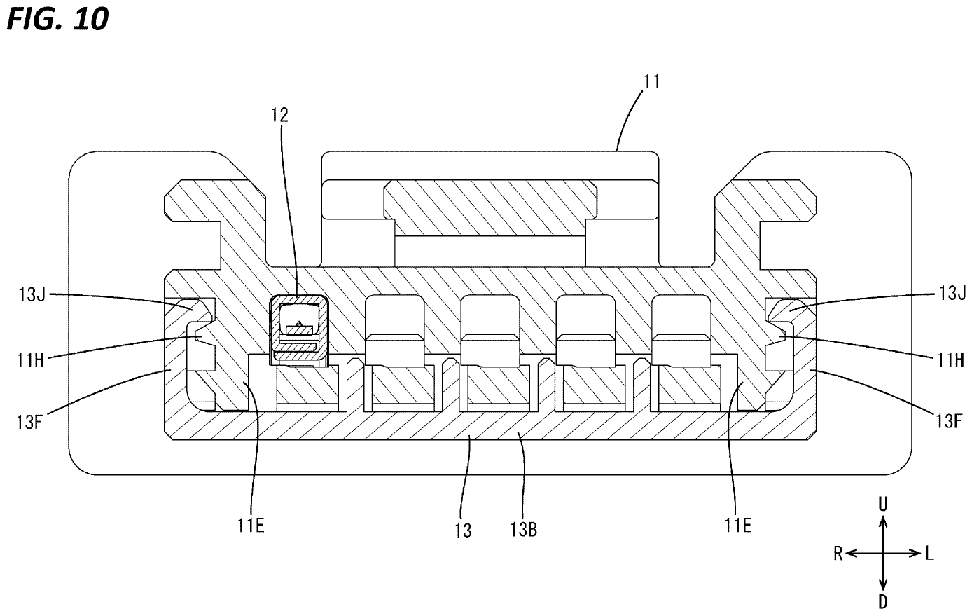

Subsequently, the movable member 13 is pushed in a direction to approach the housing 11 (upward). Then, the close position projections 13G of the first locking portions 13E pass upward through the locking claws 11K of the extending portions 11E of the housing 11 and are locked to the locking claws 11K (see FIG. 9). Along with this, the complete locking projections 11H of the extending portions 11E of the housing 11 are additionally locked to the locking claws 13J with the locking claws 13J of the second locking portions 13F facing downward (see FIG. 10). In this way, the outer wall portion 13B comes closer to the locking lances 11B, suppresses downward resilient deformation of the locking lances 11B and is arranged at the close position to hold the locking lances 11B in the state locked to the retaining portions 12B of the terminal fittings 12 as shown in FIG. 11. The interval between the lower surface of the locking lance 11B and the upper surface of the outer wall portion 13B at the close position is set to be smaller than the dimension necessary to disengage the locking lance 11B from the terminal fitting 12. A moving direction of the outer wall portion 13B to the separated position and the close position is the vertical direction (deflection direction of the locking lance 11B).

The retainer 13A is deeply inserted into the retainer insertion hole 11G. The locking portions 13C of the retainer 13A are arranged behind and adjacent to the rear ends of the box portions 12A of the terminal fittings 12 inserted to the proper positions in the cavities 11A. In this way, the retainer 13A is arranged at the complete locking position for locking and retaining the terminal fittings 12 inserted to the proper positions in the cavities 11A when the outer wall portion 13B is at the close position.

The opening dimension in the vertical direction of the jig insertion opening 10A at this time is smaller than the insertable dimension Sp when the outer wall portion 13B is at the separated position. In this way, the insertion of the jig J into the jig insertion opening 10A is suppressed. When the outer wall portion 13B is at the close position, the opening dimension in the vertical direction of the jig insertion opening 10A is an insertion suppressing dimension Ss, which is smaller than the insertable dimension Sp when the outer wall portion 13B is at the close position and suppresses the insertion of the jig J.

Next, functions of this embodiment are described.

The connector 10 of this embodiment is provided with the housing 11, the locking lances 11B, the opening 11F and the outer wall portion 13B. The housing 11 includes the cavities 11A, into which the terminal fittings 12 are inserted. The locking lance 11B locks and retains the terminal fitting 12 inserted into the cavity 11A and is resiliently deformable. The opening 11F is open in the outer wall surface of the housing 11 and can expose the locking lances 11B on the outer wall surface. The outer wall portion 13B is attached to the housing 11 to cover the opening 11F. The outer wall portion 13B moves to the separated position where the outer wall portion 13 are separated from the locking lances 11B to allow the resilient deformation of the locking lances 11B and the close position where the outer wall portion 13B is close to the locking lances 11B to suppress the resilient deformation of the locking lances 11B and hold the locking lances 11B in the state locked to the terminal fittings 12. According to this configuration, by moving the outer wall portion 13B to the separated position in inserting or withdrawing the terminal fittings 12 into or from the cavities 11A, a space is formed where the locking lances 11B are resiliently deformable. After the terminal fittings 12 are inserted to the proper positions in the cavities 11A, the space for the resilient deformation of the locking lances 11B can be eliminated by moving the outer wall portion 13B to the close position. In this way, it is possible to suppress the formation of a dead space in the housing 11 after the terminal fittings 12 are inserted into the cavities 11A.

The connector 10 of the present disclosure is further provided with the retainer 13A to be attached to the housing 11. The outer wall portion 13B is integrally formed to the retainer 13A. When the outer wall portion 13B is at the separated position, the retainer 13A is arranged at the temporary locking position for allowing the insertion of the terminal fittings 12 into the cavities 11A. When the outer wall portion 13B is at the close position, the retainer 13A is arranged at the complete locking position for locking and retaining the terminal fittings 12 inserted to the proper positions in the cavities 11A. According to this configuration, since the outer wall portion 13B and the retainer 13A are integrally formed, the outer wall portion 13B and the retainer 13A can be collectively moved. In this way, two functions of suppressing the resilient deformation of the locking lances 11B and completely locking the terminal fittings 12 can be exhibited by one operation.

In the connector 10 of the present disclosure, the jig insertion opening 10A, through which the jig J for operating the locking lance 11B is inserted, is open between the front end of the housing 11 and the front end part of the outer wall portion 13B. When the outer wall portion 13B is at the separated position, the opening dimension of the jig insertion opening 10A in the moving direction of the outer wall portion 13B to the separated position and the close position is the insertable dimension Sp for enabling the insertion of the jig J. When the outer wall portion 13B is at the close position, the opening dimension is the insertion suppressing dimension Ss for suppressing the insertion of the jig J. According to this configuration, the insertion of the jig J can be suppressed when the outer wall portion 13B is at the close position and the resilient deformation of the locking lances 11B is suppressed.

In the connector 10 of the present disclosure, the housing 11 includes the plurality of cavities 11A, and the outer wall portion 13B includes the partition walls 13D for partitioning the jig insertion opening 10A to correspond to the respective cavities 11A. According to this configuration, the jig J is reliably and easily inserted into the necessary cavity 11A.

In the connector 10 of the present disclosure, the front end part of the housing 11 is formed with the penetrating insertion holes 11C, through which the mating terminal fittings T are inserted into the cavities 11A, and provided with the partitioning portions 11D for partitioning the insertion holes 11C and the jig insertion opening 10A. According to this configuration, erroneous insertion of the jig J into the cavity 11A can be prevented by the partitioning portion 11D.

The outer wall portion 13B of the connector 10 of the present disclosure is arranged in front of the retainer 13A on front end part of the housing 11. The front end part of the outer wall portion 13B is provided with the first locking portions 13E to be locked to the housing 11. The second locking portions 13F to be locked to the housing 11 are provided behind the first locking portions 13E on the outer wall portion 13B. According to this configuration, by locking the front end part of the outer wall portion 13B to the housing 11 by the first locking portions 13E, it can be suppressed that the position of the front end part of the outer wall portion 13B with respect to the housing 11 becomes unstable.

In the connector 10 of the present disclosure, a stress generated during the resilient deformation of the locking lance 11B is within the resilience limit range of the locking lance 11B when the locking lance 11B is deformed to contact the outer wall portion 13B at the separated position. According to this configuration, the plastic deformation of the locking lance 11B (the locking lance 11B kept deformed) can be prevented.

### Other Embodiments of Present Disclosure

The present disclosure is not limited to the above described and illustrated embodiment. The present invention includes all changes in the scope of claims and in the meaning and scope of equivalents and also includes the following embodiments.

(1) Unlike the embodiment, only the second locking portions may be provided without providing the first locking portions.

(2) The terminal fittings may be male terminal fittings.

(3) The number of the cavities is not limited to the number in the embodiment.

(4) Unlike the embodiment, the movable member and the housing may be integrally formed to be linked by a bendable hinge.

### LIST OF REFERENCE NUMERALS

10 . . . connector
10A . . . jig insertion opening
11 . . . housing
11A . . . cavity
11B . . . locking lance
110 . . . insertion hole
11D . . . partitioning portion
11E . . . extending portion
11F . . . opening
11G . . . retainer insertion hole
11H . . . complete locking projection
11J . . . temporary locking projection
11K . . . locking claw
12 . . . terminal fitting
12A . . . box portion
12B . . . retaining portion
13 . . . movable member
13A . . . retainer
13B . . . outer wall portion
13C . . . locking portion
13D . . . partition wall
13E . . . first locking portion
13F . . . second locking portion
13G . . . close position projection
13H . . . separated position projection
13J . . . locking claw
31 . . . wire
J . . . jig
S . . . deflection allowing space
Sp . . . insertable dimension
Ss . . . insertion suppressing dimension
T . . . mating terminal fitting

1. A connector, comprising:
a housing including a cavity, a terminal fitting being inserted into the cavity;
a resiliently deformable locking lance for locking and retaining the terminal fitting inserted into the cavity;
an opening open in an outer wall surface of the housing, the opening enabling the locking lance to be exposed on the outer wall surface; and
an outer wall portion to be attached to the housing to cover the opening,
the outer wall portion moving to:
a separated position separated from the locking lance to allow resilient deformation of the locking lance; and
a close position close to the locking lance to hold the locking lance in a state locked to the terminal fitting by suppressing the resilient deformation of the locking lance,
one extending portion being provided on each of both lateral side edges of the housing,
a pair of first locking portions to be locked to the extending portions and a pair of second locking portions to be locked to the extending portions being provided on both lateral side edges of the outer wall portion,
the pair of first locking portions being arranged between the pair of extending portions, and
the pair of second locking portions being arranged to cover laterally outer sides of the pair of extending portions.

2. The connector of claim 1, further comprising a retainer to be attached to the housing, wherein:
the outer wall portion is integrally formed to the retainer,
the retainer is arranged at a temporary locking position for allowing insertion of the terminal fitting into the cavity when the outer wall portion is at the separated position, and
the retainer is arranged at a complete locking position for locking and retaining the terminal fitting inserted to a proper position in the cavity when the outer wall portion is at the close position.

3. The connector of claim 1, wherein:
a jig insertion opening is open between a front end of the housing and a front end part of the outer wall portion, a jig for operating the locking lance being inserted through the jig insertion opening,
an opening dimension of the jig insertion opening in a moving direction of the outer wall portion to the separated position and the close position is an insertable dimension for enabling insertion of the jig when the outer wall portion is at the separated position,
the opening dimension is an insertion suppressing dimension for suppressing the insertion of the jig when the outer wall portion is at the close position.

4. The connector of claim 3, wherein:
the housing includes a plurality of the cavities, and
the outer wall portion includes a partition wall for partitioning the jig insertion opening to correspond to the respective cavities.

5. The connector of claim 3, wherein:
a front end part of the housing is formed with a penetrating insertion hole, a mating terminal fitting being inserted into the cavity through the insertion hole, and provided with a partitioning portion for partitioning the insertion hole and the jig insertion opening.

6. The connector of claim 2, wherein:
the outer wall portion is arranged in front of the retainer on a front end part of the housing,
a front end part of the outer wall portion is provided with a first locking portion to be locked to the housing, and
a second locking portion to be locked to the housing is provided behind the first locking portion on the outer wall portion.

7. The connector of claim 1, wherein a stress generated during resilient deformation of the locking lance is within a resilience limit range of the locking lance when the locking lance is deformed to contact the outer wall portion at the separated position.
